(19) United States
(12) Patent Application Publication
(10) Pub. No.: US 2015/0044381 A1
(43) Pub. Date: Feb. 12, 2015

(54) METAL OXIDE SOLUTION IN ORGANIC SOLVENT FOR FABRICATING HIGH REFRACTIVE FILM, METHOD OF PREPARING THE SAME AND METHOD OF FABRICATING HIGH REFRACTIVE FILM USING THE SAME

(71) Applicant: Electronics and Telecommunications Research Institute, Daejeon (KR)

(72) Inventors: Seung Koo PARK, Daejeon (KR); Jeong Ik LEE, Daejeon (KR); Byoung Kuk KANG, Seoul (KR); Doo-Hee CHO, Daejeon (KR); Jaehyun MOON, Daejeon (KR); Jin Wook SHIN, Daejeon (KR); Hye Yong CHU, Daejeon (KR)

(73) Assignee: Electronics and Telecommunications Research Institute, Daejeon (KR)

(21) Appl. No.: 14/334,218

(22) Filed: Jul. 17, 2014

(30) Foreign Application Priority Data
Aug. 9, 2013 (KR) 20-2013-0094919

(51) Int. Cl. C09D 1/00; B05D 3/02; B05D 1/26; C09D 7/00; B05D 1/00

(52) U.S. Cl. CPC C09D 1/00; C09D 7/001; B05D 1/005; B05D 1/26; B05D 3/0254
USPC 427/385.5; 106/287.24; 106/287.25; 106/287.17; 106/287.18; 106/287.19; 427/240

(57) ABSTRACT

Provided are a metal oxide solution in organic solvent for a high refractive film, a method of preparing the same, and a method of fabricating a high refractive film using the same. The method of preparing the metal oxide solution in organic solvent for fabricating a high refractive film includes preparing a metal oxide precursor, preparing an organic solvent containing a carbonyl group, forming a metal oxide through a sol-gel reaction of the metal oxide precursor in the organic solvent in the presence of an acidic catalyst, and reacting the metal oxide and the organic solvent. The hydrogen bonding between the metal oxide and the organic solvent occurs.

### CROSS-REFERENCE TO RELATED APPLICATIONS

This U.S. non-provisional patent application claims priority under 35 U.S.C. §119 to Korean Patent Application No. 10-2013-0094919, filed on Aug. 9, 2013, the entire contents of which are hereby incorporated by reference.

### BACKGROUND OF THE INVENTION

Embodiments of the present inventive concepts relate to a metal oxide solution in organic solvent for fabricating high refractive films, methods of fabricating the same and methods of fabricating high refractive films using the same.

A high refractive film with refractive index of at least 2.0 in a visible region is generally fabricated by coating a sol solution in which inorganic oxides with high refractive index and a size of a few tens of nanometers are dispersed and forming an inorganic oxide film. The inorganic oxide sol solution is formed by using a corresponding precursor with a reaction medium such as water or alcohol by a sol-gel reaction in the presence of an acid or base catalyst. This is called as a sol-gel synthesis. The inorganic oxide sol solution has a homogeneously dispersed state of inorganic materials with the size of a few tens nanometers in a solvent such as water or alcohol. In process of time, the inorganic oxide may be precipitated in the solution due to the increase of the particle size according to the condensation reaction between sols. When the concentration of the inorganic oxide sol is high, this phenomenon may be promoted. Thus, the concentration of the inorganic oxide in the solution could not be increased considering the stability of the solution.

Generally, an inorganic oxide layer is formed by coating an inorganic oxide sol solution on the surface of a support, and annealing inorganic oxide particles arranged on the surface of the support at about 400° C. or above. Since the concentration of the inorganic oxide sol solution is low, the film thus obtained is a thin film with the thickness of about 100 nm or less. On the contrary, an organic film including a polymer as a main component has good flexibility and transmittance. In addition, a thick film with the thickness of about a few hundreds of micrometers may be formed at a relatively low temperature. However, the formation of a film with refractive index of about 1.8 or more is difficult because of the chemical structure of a polymer organic material and a free volume occupied by the polymer.

By combining an organic polymer with good properties in view of layer properties with an inorganic oxide with high refractive index in view of optical properties, a method of introducing an inorganic oxide such as titanium oxide and zirconium oxide into a polymer is well known. Methods of introducing the inorganic oxide in the polymer include a method of forming a composite material by simply mixing the polymer with the inorganic oxide, and a method of forming a hybrid type of the polymer and the inorganic oxide by chemically bonding the polymer and the inorganic oxide.

The composite material is likely to generate a phase separation because of different properties of the polymer and the inorganic oxide. When the content of the inorganic oxide is low, the inorganic oxide may be mixed well in the matrix polymer. However, when the content increases, the concentration of the inorganic oxide in the composite material increases, and the interaction between inorganic oxides increases. Thus, the phase separation is generated between the polymer and the inorganic oxide. When the polymer and the inorganic oxide are mixed, an inorganic oxide sol solution or an inorganic oxide nano powder may be used.

A method of introducing an inorganic oxide in a polymer through the chemical reaction of an inorganic oxide precursor used in the synthesis of the inorganic oxide with an organic polymer is referred to as an organic/inorganic hybrid method. In an organic/inorganic hybrid solution obtained by the synthetic method, the inorganic oxide is chemically bonded with the polymer and is stable in the solution. An organic/inorganic hybrid film is formed by forming a film using the organic/inorganic hybrid solution and annealing at 400° C. or less considering the heat resistance of the polymer. In this case, the polymer is necessary to be thermally stable and to have a reactive group such as a hydroxyl group and or a carboxyl group that may react with the inorganic oxide precursor. Thus, the selection of a monomer for the synthesis of the polymer for the preparation of the organic/inorganic hybrid solution is limited. In addition, during the fabrication of the organic/inorganic film, the polymer may remain after performing a high temperature process. Thus, the transparency of the film may decrease due to yellowing of an organic material, and the refractive index of the film may decrease.

### SUMMARY OF THE INVENTION

The present invention provides a metal oxide solution in organic solvent for fabricating a high refractive film, in which the stability of the metal oxide in the solution is good because a reverse reaction of sol-gel reaction is not accompanied, and a film with high refractive index and high transmittance may be formed at a low annealing temperature, a method of preparing the same, and a high refractive film fabricated by using the same.

Embodiments of the present invention provide metal oxide solutions in organic solvent for fabricating a high refractive film including a metal oxide, and an organic solvent containing a carbonyl group. A hydrogen bonding between the metal oxide and the organic solvent is formed.

In some embodiments, the metal oxide solution in organic solvent for fabricating a high refractive film may be represented by following Formula 1.

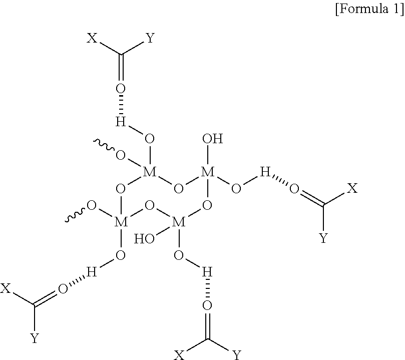

where M is a metal including at least one metal in groups 3 to 5 and 13 to 15 in the periodic table of elements, and X and Y are an aliphatic or aromatic group in which carbon, oxygen, and/or nitrogen are continuously combined with the carbonyl group in the organic solvent. X and Y may be chemically bonded.

In other embodiments, the metal oxide may include at least one metal component among Al, Sb, Zr, Hf, Sn, In, Ti, and Si.

In still other embodiments, the organic solvent may be at least one selected from the group consisting of a carboxylic acid-based solvent, an amide-based solvent, an ester-based solvent, and a ketone-based solvent.

In other embodiments of the present invention, methods of preparing a metal oxide solution in organic solvent for fabricating a high refractive film include preparing a metal oxide precursor, preparing an organic solvent containing a carbonyl group, forming a metal oxide through a sol-gel reaction of the metal oxide precursor in the organic solvent in the presence of an acidic catalyst, and reacting the metal oxide and the organic solvent. A hydrogen bonding between the metal oxide and the organic solvent is formed.

In some embodiments, the acidic catalyst may include an aqueous hydrochloric acid solution.

In other embodiments, the metal oxide may include at least one metal component among Al, Sb, Zr, Hf, Sn, In, Ti, and Si.

In still other embodiments, the organic solvent may be at least one selected from the group consisting of a carboxylic acid-based solvent, an amide-based solvent, an ester-based solvent, and a ketone-based solvent.

In still other embodiments of the present invention, methods of fabricating a high refractive film include preparing a metal oxide precursor, preparing an organic solvent containing a carbonyl group, forming a metal oxide through a sol-gel reaction of the metal oxide precursor in the organic solvent in the presence of an acidic catalyst, preparing a metal oxide solution in organic solvent for fabricating a high refractive film by reacting the metal oxide and the organic solvent, coating the metal oxide solution in organic solvent for fabricating a high refractive film on a substrate, and annealing the solution layer for fabricating a high refractive film. A hydrogen bonding between the metal oxide and the organic solvent in the organic solution of a metal oxide for fabricating a high refractive film is formed.

In some embodiments, the coating of the metal oxide solution in organic solvent for fabricating a high refractive film on the substrate may include a spin coating, a deep coating, or an inkjet printing process.

In other embodiments, the annealing process may be performed between about 150 to 400° C.

According to an embodiment of the inventive concept, the film prepared from the metal oxide solution in organic solvent shows high refractive indices because the content of the metal oxide is high in the solutions due to the formation of the hydrogen bonging between the metal oxide and the organic solvent and because the organic compound is completely removed during forming the film.

In addition, since the metal oxide makes a hydrogen bond with the organic solvent, a reverse reaction of sol-gel reaction is not accompanied during storing the metal oxide solution, and the stability of the solution may be improved. Since the metal oxide hydrogen bonded with the organic solvent is stable in the solution, the concentration of the metal oxide in the solution may increase. Since the organic solvent hydrogen-bonded or not may be evaporated at the boiling point of the solvent or above, a metal oxide layer with a high concentration may be formed. Thus, the film with high refractive index may be formed by a low temperature process in at which the organic solvent may be evaporated.

In addition, since a sintering process, that is carried out at a high temperature and is one of general processes for an inorganic oxide film formation, is not conducted, the high refractive film fabricated by at the low temperature may be a relatively thick.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a method of preparing a metal oxide solution in organic solvent for forming a high refractive film and a method of fabricating a high refractive film using the same according to an embodiment of the inventive concept;

FIG. 2 is a graph illustrating the refractive index and thickness of the films fabricated by Example 4 with respect to a wavelength;

FIG. 3 is a graph illustrating transmittance of the films fabricated by Example 4 with respect to a wavelength;

FIG. 4 is a graph illustrating the refractive index and thickness of the films fabricated by Example 5 with respect to a wavelength;

FIG. 5 is a graph illustrating the refractive index and thickness of the films fabricated by Example 6 with respect to a wavelength; and

FIG. 6 is a graph illustrating the results of infrared spectroscopy of the high refractive films fabricated by Examples 1 and 4.

### DETAILED DESCRIPTION OF PREFERRED EMBODIMENTS

The advantages and the features of the inventive concept, and methods for attaining them will be described in example embodiments below with reference to the accompanying drawings. The inventive concept may, however, be embodied in different forms and should not be construed as limited to the embodiments set forth herein. Rather, these embodiments are provided so that this description will be thorough and complete, and will fully convey the scope of the present inventive concept to those skilled in the art. Like reference numerals refer to like elements throughout.

The terminology used herein is for the purpose of describing particular example embodiments only and is not intended to limit the present inventive concept. As used herein, the singular forms are intended to include the plural forms as well, unless the context clearly indicates otherwise. It will be further understood that the terms “comprises” and/or “comprising,” when used in this specification, specify the presence of stated features, steps, operations, and/or devices, but do not preclude the presence or addition of one or more other features, steps, operations, and/or devices thereof. It will also be understood that when a layer (or film) is referred to as being ‘on’ another layer or substrate, it can be directly on the other layer or substrate, or third intervening layers may also be present.

Hereinafter, it will be described about an exemplary embodiment of the present invention in conjunction with the accompanying drawings.

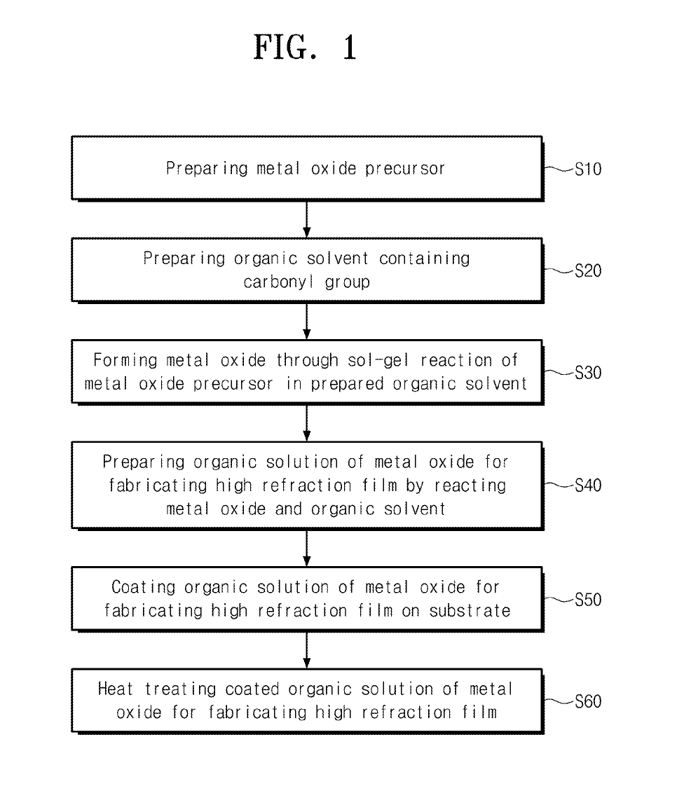

FIG. 1 is a flowchart illustrating a method of preparing a metal oxide solution in organic solvent for forming a high refractive film and a method of fabricating a high refractive film using the same according to an embodiment of the inventive concept.

Referring to FIG. 1, a method of preparing a metal oxide solution in organic solvent for fabricating a high refractive film according to an embodiment of the inventive concept may include preparing a metal oxide precursor (Step S10), preparing an organic solvent containing a carbonyl group (Step S20), forming a metal oxide by conducting a sol-gel reaction of the metal oxide precursor in the organic solvent thus prepared (Step S30), and forming a metal oxide solution in organic solvent for fabricating a high refractive film by reacting the metal oxide and the organic solvent (Step S40).

In detail, the metal oxide precursor may include all kinds of precursors including at least one metal among the metals in groups 3 to 5 and 13 to 15 in the periodic table of elements as a center atom and an organic functional group, however is not limited thereto. In an embodiment, the metal oxide precursor may include a metal alkoxide. For example, the metal alkoxide used in the inventive concept may include at least one among tin(IV) ter-butoxide, titanium butoxide, titanium ethoxide, titanium methoxide, titanium iso-propoxide, titanium propoxide, aluminum ethoxide, aluminum iso-propoxide, aluminum phenoxide, aluminum tert-butoxide, aluminum tri-butoxide, aluminum tri-sec-butoxide, indium(III) tert-butoxide, antimony(III) butoxide, antimony(III) ethoxide, antimony(III) methoxide, antimony(III) propoxide, hafnium(IV) n-butoxide, hafnium(IV) tert-butoxide, zirconium(IV) butoxide, zirconium(IV) ethoxide, zirconium(IV) iso-propoxide, zirconium(IV) propoxide, zirconium(IV) tert-butoxide, tetrabutyl orthosilicate, tetraethyl orthosilicate, tetramethyl orthosilicate, and tetrapropyl orthosilicate.

The organic solvent may include an organic compound containing a carbonyl group so as to make a chemical bond with the metal oxide formed by the sol-gel reaction of the metal oxide precursor. In an embodiment, the organic solvent may include at least one selected from the group consisting of a carboxylic acid-based solvent, an amide-based solvent, an ester-based solvent, and a ketone-based solvent.

For example, the amide-based solvent may include at least one among 1-methyl-2-pyrrolidinone, formamide, N-methylformamide, N,N-dimethylformamide, N-ethylformamide, N,N-dimethylacetamide, and N,N-diethylacetamide. For example, the ester-based solvent may include at least one among diethylcarbonate, methyl acetate, ethyl acetate, ethyl lactate, ethylene glycol monomethyl ether acetate, propylene glycol monomethyl ether acetate, and ethylene glycol diacetate. For example, the ketone-based solvent may include at least one among methyl ethyl ketone, methyl isobutyl ketone, diethyl ketone, methyl n-propyl ketone, methyl n-butyl ketone, cyclopentanone, cyclohexanone, methyl cyclohexanone, and acetylacetone.

The sol-gel reaction of the metal oxide precursor occurs in an organic solvent in the presence of an acidic catalyst to prepare a metal oxide (Step S30), and the metal oxide and the organic solvent may react to form a metal oxide solution in organic solvent for fabricating a high refractive film (Step S40). In this case, the processes (Steps S30 and S40) may be conducted simultaneously. The metal oxide solution for fabricating a high refractive film may be a liquid type. The organic solvent may react with the sol-gel reaction product of the metal oxide precursor and may be chemically bonded to the metal oxide thus formed at the same time. That is, the metal oxide solution in organic solvent for fabricating a high refractive film may be a material in which the hydrogen bonding between the metal oxide and the organic solvent is formed.

The metal oxide solution in organic solvent for fabricating a high refractive film may be represented by the following Formula 1.

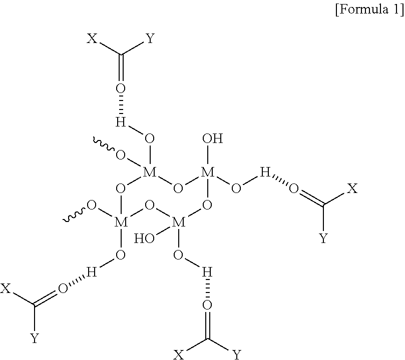

In Formula 1, M may be a metal including at least one metal in groups 3 to 5 and 13 to 15 in the periodic table of elements, and X and Y may be an aliphatic or aromatic group in which carbon, oxygen, and/or nitrogen is continuously combined with a carbonyl group in the organic solvent. X and Y may be chemically bonded.

The acidic catalyst may include at least one selected from the group consisting of hydrochloric acid, nitric acid, sulfuric acid, phosphoric acid, hydrofluoric acid, formic acid, acetic acid, propionic acid, butanoic acid, pentanoic acid, hexanoic acid, monochloroacetic acid, dichloroacetic acid, trichloroacetic acid, trifluoroacetic acid, oxalic acid, malonic acid, sulfonic acid, phthalic acid, fumaric acid, citric acid, maleic acid, oleic acid, methylmalonic acid, adipic acid, p-aminobenzoic acid, and p-toluenesulfonic acid, and is not limited thereto.

Reaction 1 illustrates the reaction of preparing an metal oxide solution in organic solvent for fabricating a high refractive film through a sol-gel reaction of titanium butoxide which is one of the metal oxide precursors in N,N-dimethylacetamide (DMAc) which is one of the organic solvents. In this case, an aqueous hydrochloric acid solution is used as the acidic catalyst.

A unreacted hydroxyl group in titanium dioxide obtained through Reaction 1 is hydrogenated under an acidic condition and makes a hydrogen bond with the carbonyl group in an amide group of DMAc. The hydrogen bond contributes to the stabilization of titanium dioxide in the DMAc solvent.

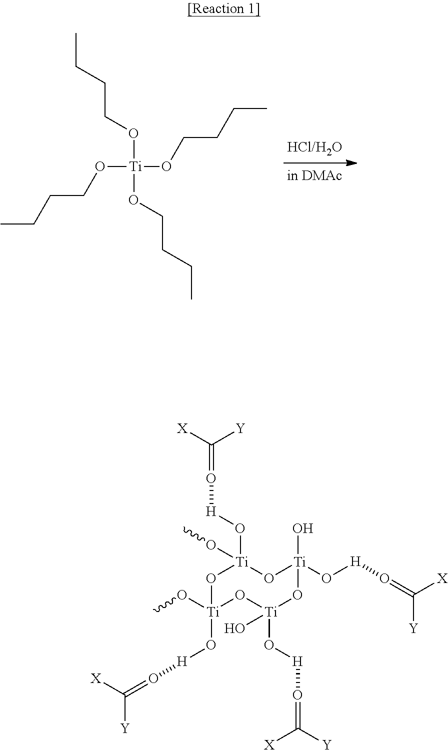

Reaction 2 illustrates the process of the reaction for preparing the titanium oxide through a sol-gel reaction of the titanium butoxide in Reaction 1 in the presence of the aqueous hydrochloric acid solution catalyst.

The titanium butoxide and water react to produce titanium hydroxide, and through the condensation reaction between hydroxyl groups, the titanium dioxide is produced. Butyl alcohol is produced while producing the titanium hydroxide, and water (H₂O) is produced while producing the titanium dioxide. During performing the reaction, the alcohol and the water may induce a reverse reaction of the titanium dioxide formation. Thus, the use of the organic solvent as the reaction medium may be favorable in view of stability because the organic solvent may not be accompanied with the reverse reaction due to the formation of the hydrogen bonding between the titanium oxide and the organic solvent. The production of the titanium hydroxide is promoted under an acid catalyst, and the condensation reaction between the hydroxyl groups is promoted under a base catalyst. However, since the reverse reaction of the the titanium dioxide formation is promoted in the presence of the base catalyst, the reaction under the acid catalyst may be favorable when considering the stability of storage. In addition, when hydrochloric acid is used as the acid catalyst, hydrochloric acid solution in water is commercially available. Thus, water is not necessary to be added into a reaction system separately.

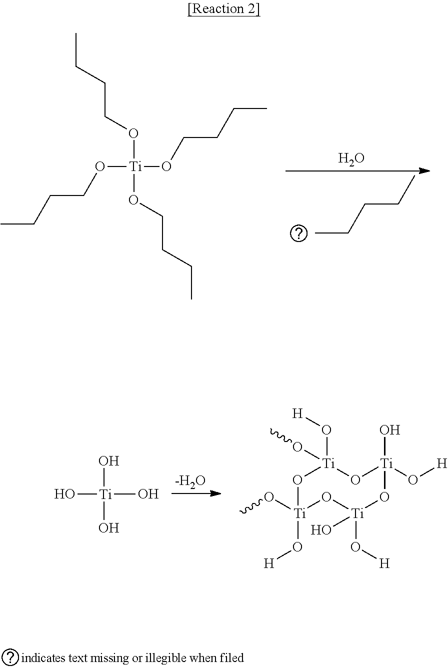

Through the above-described sol-gel reaction, various kinds of networks of a metal oxide may be formed from the metal alkoxide monomer precursor.

Generally, water or an alcohol is used as a reaction medium for the sol-gel reaction of a metal oxide precursor. The metal oxide prepared from the sol-gel reaction is unstable in the medium because a reverse reaction of the sol-gel reaction is accompanied with the sol-gel reaction during performing the reaction or during storing a solution produced after the reaction, resulting in the instability of the metal oxide sol in the solution. When an organic solvent containing a carbonyl group is used as the reaction medium of the sol-gel reaction according to an embodiment of the inventive concept, the organic solvent may make a hydrogen bond with an unreacted hydroxyl group of the metal oxide. Thus, the reverse reaction is not generated, and the stability of the metal oxide sol in the solution may be improved.

Referring to FIG. 1 in succession, the method of fabricating a high refractive film according to an embodiment of the inventive concept may include coating the metal oxide solution in organic solvent for fabricating a high refractive film on a substrate (Step S50), and annealing the coated the metal oxide solution in organic solvent for fabricating a high refractive film (Step S60).

The substrate may include a semiconductor substrate, a glass substrate, or a plastic substrate, and is not limited thereto. The method for coating the metal oxide solution in organic solvent for fabricating a high refractive film on the substrate may include a spin coating, a deep coating, or an inkjet printing process.

The annealing process may be performed between about 150 to 400° C. The unreacted organic solvent may be removed through the annealing process by increasing the temperature to at least the boiling point of the organic solvent in the metal oxide solution in organic solvent, resulting in a high refractive film including mostly the metal oxide may be fabricated.

### Example 1

Under nitrogen, 4.5 g of DMAc was added into a 50 ml two-necked flask, and 1.31 g of 37% aqueous hydrochloric acid solution was slowly and dropwise added into the flask. After added the aqueous hydrochloric acid solution, 3 g of titanium butoxide was slowly added drop by drop into the flask. Then, the reaction was performed at room temperature under nitrogen for about 24 hours. The reactant was filtered using a 0.2 μm filter to prepare a metal oxide solution in organic solvent for fabricating a high refractive film.

### Example 2

Under nitrogen, 4.5 g of cyclopentanone was added into a 50 ml two-necked flask, and 1.31 g of 37% aqueous hydrochloric acid solution was slowly and dropwise added into the flask. After added the aqueous hydrochloric acid solution, 3 g of titanium butoxide was slowly added drop by drop into the flask. Then, the reaction was performed at room temperature under nitrogen for about 24 hours. The reactant was filtered using a 0.2 μm filter to prepare a metal oxide solution in organic solvent for fabricating a high refractive film.

### Example 3

Under nitrogen, 4.5 g of 1-methyl-2-pyrrolidinone was added into a 50 ml two-necked flask, and 1.31 g of 37% aqueous hydrochloric acid solution was slowly and dropwise added into the flask. After added the aqueous hydrochloric acid solution, 3 g of titanium butoxide was slowly added drop by drop into the two-necked flask. Then, the reaction was performed at room temperature under nitrogen for about 24 hours. The reactant was filtered using a 0.2 μm filter to prepare a metal oxide solution in organic solvent for fabricating a high refraction film.

### Example 4

The metal oxide solution in organic solvent for fabricating a high refractive film prepared in Example 1 was spin-coated (3,000 rpm/30 seconds) on a silicon wafer, and dried at 150° C., 200° C., 250° C. and 400° C. for 2 hours to fabricate films with a thickness of from about 90 nm to 150 nm. The refractive index and the thickness of the films thus fabricated were measured by using an ellipsometer.

### Example 5

The metal oxide solution in organic solvent for fabricating a high refractive film prepared in Example 2 was spin-coated (3,000 rpm/30 seconds) on a silicon wafer, and dried at 150° C., 200° C., 250° C. and 400° C. for 2 hours to fabricate films with a thickness of from about 150 nm to 210 nm. The refractive index and the thickness of the films thus fabricated were measured by using an ellipsometer.

### Example 6

The metal oxide solution in organic solvent for fabricating a high refractive film prepared in Example 3 was spin-coated (3,000 rpm/30 seconds) on a silicon wafer, and dried at 150° C., 200° C., 250° C. and 400° C. for 2 hours to fabricate films with a thickness of from about 150 nm to 250 nm. The refractive index and the thickness of the films thus fabricated were measured by using an ellipsometer.

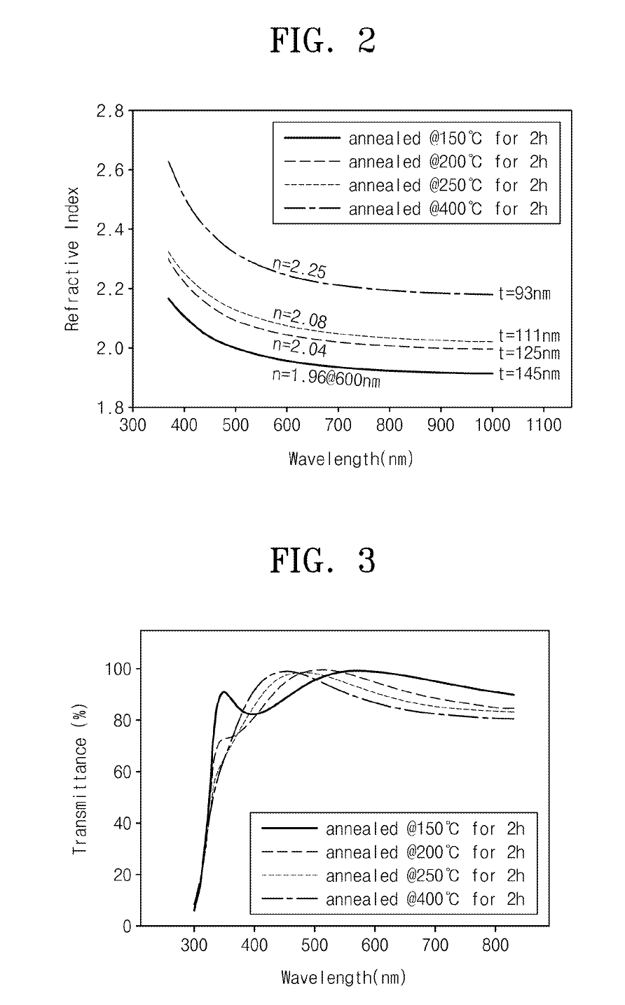

FIG. 2 is a graph illustrating refractive index of high refraction films fabricated by Example 4 with respect to thickness and wavelength.

Referring to FIG. 2, the refractive index of the film at a wavelength of about 600 nm was very high, about 1.96, even when it was annealed at comparatively low temperature, 150° C. and the film was thick, about 145 nm. In addition, it would be found that a film with the refractive index of about 2.0 or more was fabricated by a low temperature process at 200° C. Further, it would be found that the refractive index increases and the film thickness decreases as the process temperature increases.

FIG. 3 is a graph illustrating transmittance of high refractive films fabricated by Example 4 with respect to wavelength.

Referring to FIG. 3, the yellowing of the film fabricated at each process temperature was not shown, and the transmittance in a visible region was almost 80% or above. Particularly, the transmittance of a film fabricated by the low temperature process at 150° C. was about 90% or above.

Even though not illustrated, when comparing SEM photographic images of the plan and the cross-sectional views of the films fabricated at 150° C. and 400° C. in Example 4, the planarity of the film fabricated by the low temperature process at 150° C. was better. The film fabricated by the high temperature process at 400° C. was crystallized. It is near a sintering temperature of titanium dioxide.

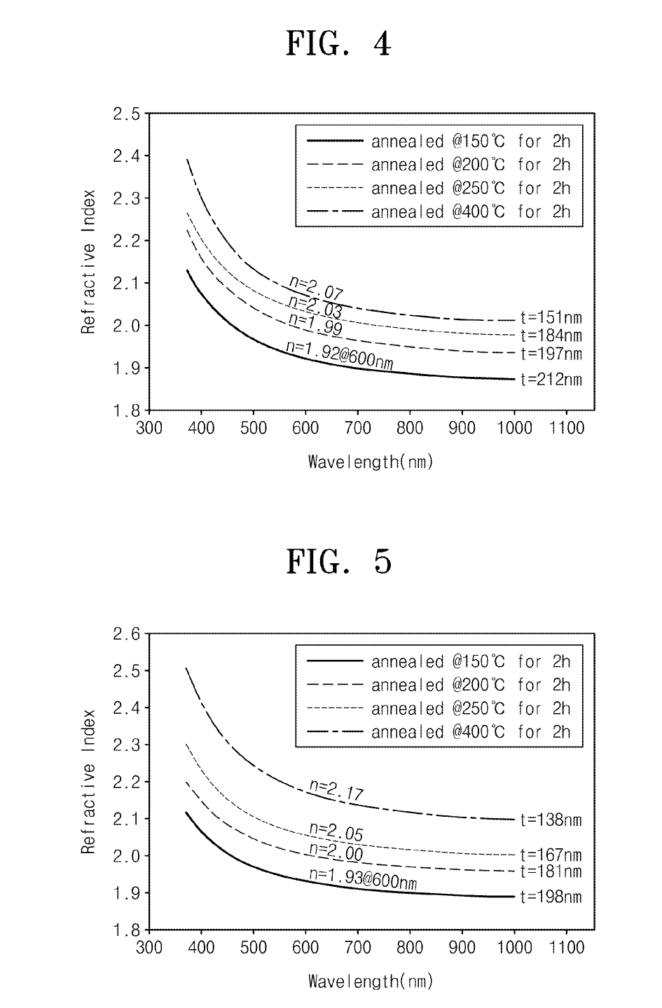

FIG. 4 is a graph illustrating refractive index of high refractive films fabricated by Example 5 with respect to thickness and wavelength.

Referring to FIG. 4, the refractive index and the thickness change of the films according to the process temperature tend to show similar pattern as in Example 4. Particularly, the thickness of the films obtained from the process at different annealing temperature in Example 5 is greater than that of the films obtained from the same annealing process in Example 4. This result is due to the higher solvent viscosity of cyclopentanone used as a solvent.

FIG. 5 is a graph illustrating refractive index of high refractive films fabricated by Example 6 with respect to thickness and wavelength.

Referring to FIG. 5, the refractive index and the thickness change of the films according to the process temperature tend to illustrate similar patterns as in Examples 4 and 5. The thickness of the films obtained from the process at different annealing temperature of in Example 6 is greater than that of the films obtained from the same annealing process in Example 4. This result is due to the higher solvent viscosity of 1-methyl-2-pyrrolidinone used as a solvent, as in Example 5.

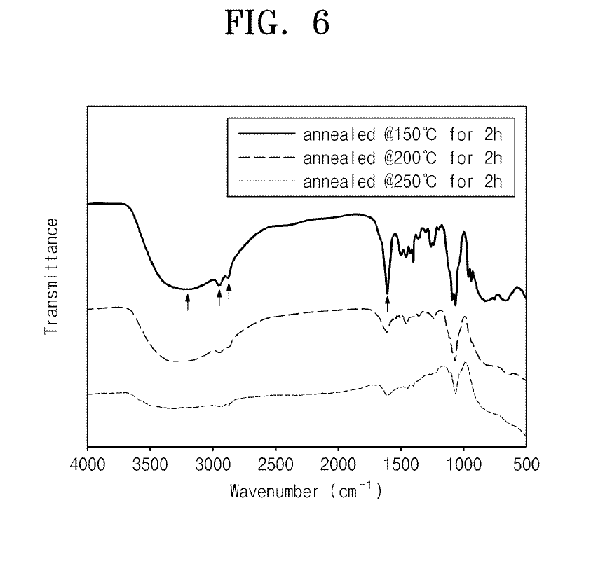

FIG. 6 is a graph illustrating the results of infrared spectroscopy of high refractive films fabricated by Examples 1 and 4. The film was spin cast on a sodium chloride (NaCl) window with the metal oxide solution prepared in Example 1 according to Example 4. Then, IR spectroscopy analysis was performed.

In FIG. 6, absorption peak at 3,200 cm⁻¹ is obtained by the stretching vibration of an unreacted hydroxyl group in the metal oxide solution in organic solvent for fabricating a high refractive film. Referring to FIG. 6, as the process temperature increases, the concentration of the unreacted hydroxyl group decreases due to the condensation reaction between the hydroxyl groups, and thus, as the process temperature increases, the absorbance of the peak decreases. The absorption peaks at 2950 cm⁻¹ and 2885 cm⁻¹ are obtained by the C—H stretching vibration of a methylene group or a methyl group due to unreacted butoxide in the metal oxide solution in organic solvent for fabricating a high refraction film, and the methyl group of DMAc remained due to the hydrogen bond. The absorption peak at 1610 cm⁻¹ is obtained by the stretching vibration of the carbonyl of the DMAc, and the absorption peak is shifted to a longer wavelength due to the hydrogen bond. As the process temperature increases, the DMAc is removed. However, it would be found that the DMAc partially remains at the process temperature of 250° C. that is higher than the evaporation temperature of DMAc.

According to an embodiment of the inventive concept, a high refractive film including metal oxide mostly may be fabricated by using a metal oxide solution in organic solvent because the organic solvent as a reaction medium for a sol-gel reaction makes a hydrogen bond with a metal oxide during preparing the metal oxide solution, and the unreacted DMAc may be completely removed during forming a the film. The refractive index of the film may increase.

In addition, since a hydrogen bonding between the metal oxide and the organic solvent occurs, a reverse reaction of the sol-gel reaction may not be accompanied during storing the solution, and the stability of the solution may be improved. Since the metal oxide making the hydrogen bond with the organic solvent is stable, the concentration of the metal oxide in the solution may increase. Since the organic solvent making the hydrogen bond or not may be evaporated at the boiling point of the solution or above, a high concentrated metal oxide layer may be formed. Thus, the film with high refractive index may be formed at a low temperature at which the organic solvent may be evaporated.

In addition, since a sintering process, that is carried out at a high temperature and is one of general processes for an inorganic oxide film formation, is not conducted, the high refractive film fabricated at the low temperature may be relatively thick.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An metal oxide solution in organic solvent for fabricating a high refractive film comprising:
a metal oxide; and
an organic solvent containing a carbonyl group,
wherein a hydrogen bonding between the metal oxide and the organic solvent occurs.

2. The metal oxide solution in organic solvent for fabricating the high refractive film of claim 1, represented by following Formula 1: 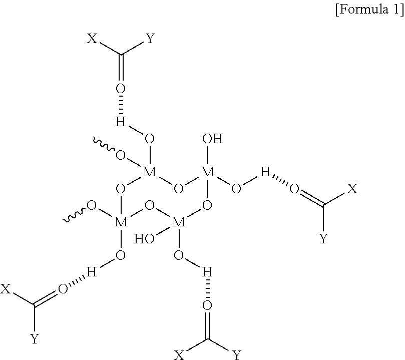
where M is a metal including at least one metal in groups 3 to 5 and 13 to 15 in the periodic table of elements, and X and Y are an aliphatic or aromatic group in which carbon, oxygen, and/or nitrogen are continuously combined with the carbonyl group in the organic solvent, and X and Y are chemically bonded.

3. The metal oxide solution in organic solvent for fabricating the high refractive film of claim 1, wherein the metal oxide comprises at least one metal component among Al, Sb, Zr, Hf, Sn, In, Ti, and Si.

4. The metal oxide solution in organic solvent for fabricating the high refractive film of claim 1, wherein the organic solvent is at least one selected from the group consisting of a carboxylic acid-based solvent, an amide-based solvent, an ester-based solvent, and a ketone-based solvent.

5. A method of preparing a metal oxide solution in organic solvent for fabricating a high refractive film, the method comprising:
preparing a metal oxide precursor;
preparing an organic solvent containing a carbonyl group;
forming a metal oxide through a sol-gel reaction of the metal oxide precursor in the organic solvent in the presence of an acidic catalyst; and
reacting the metal oxide and the organic solvent,
wherein a hydrogen bonding between the metal oxide and the organic solvent occurs.

6. The method of preparing the metal oxide solution in organic solvent for fabricating the high refractive film of claim 5, wherein the acidic catalyst comprises an aqueous hydrochloric acid solution.

7. The method of preparing the metal oxide solution in organic solvent for fabricating the high refractive film of claim 5, wherein the metal oxide comprises at least one metal component among Al, Sb, Zr, Hf, Sn, In, Ti, and Si.

8. The method of preparing then metal oxide solution in organic solvent for fabricating the high refractive film of claim 5, wherein the organic solvent is at least one selected from the group consisting of a carboxylic acid-based solvent, an amide-based solvent, an ester-based solvent, and a ketone-based solvent.

9. A method of fabricating a high refractive film, the method comprising:
preparing a metal oxide precursor;
preparing an organic solvent containing a carbonyl group;
forming a metal oxide through a sol-gel reaction of the metal oxide precursor in the organic solvent in the presence of an acidic catalyst;
preparing a metal oxide solution in organic solvent for fabricating a high refractive film by reacting the metal oxide and the organic solvent;
coating the metal oxide solution in organic solvent for fabricating the high refractive film on a substrate; and
annealing the coated metal oxide solution for fabricating the high refractive film,
wherein a hydrogen bonding between the metal oxide and the organic solvent in the metal oxide solution for fabricating the high refractive film occurs.

10. The method of fabricating the high refractive film of claim 9, wherein the coating of the metal oxide solution in organic solvent for fabricating the high refractive film on the substrate includes a spin coating, a deep coating, or an inkjet printing process.

11. The method of fabricating the high refractive film of claim 9, wherein the annealing is performed from about 150° C. to 400° C.
